(19) United States
(12) Patent Application Publication
(10) Pub. No.: US 2025/0020683 A1
(43) Pub. Date: Jan. 16, 2025

(54) METHOD FOR CONTROLLING AN ANTI DROPLET SYSTEM OF A PIPETTOR AND PIPETTOR WITH ANTI DROPLET SYSTEM CONTROL

(71) Applicant: Roche Molecular Systems, Inc., Pleasanton, CA (US)

(72) Inventors: Christian Ettel, Schwyz (CH); Alan Furlan, Lucerne (CH); Alexander Meier, Zürich (CH)

(21) Appl. No.: 18/711,362

(22) PCT Filed: Nov. 16, 2022
(86) PCT No.: PCT/EP2022/082076

§ 371 Date: May 17, 2024

(30) Foreign Application Priority Data
Nov. 18, 2021 (EP) 21208918.9

(51) Int. Cl. G01N 35/10

(52) U.S. Cl. CPC G01N 35/1016; G01N 2035/102

(57) ABSTRACT

A method for controlling a laboratory system or device comprising at least one pipettor with a pressure sensor, at least one humidity sensor, at least one temperature sensor, and a control unit. The control unit receiving a humidity value from the humidity sensor and a temperature value from the temperature sensor, comparing the pair of humidity and temperature values with a threshold database connected to the control unit, the threshold database comprising, for different pairs of humidity and temperature values, instructions to activate or deactivate an anti droplet control system of the pipettor, determining if the anti droplet system of the pipettor has to be activated or deactivated, activating or deactivating said anti droplet system of the pipettor.

### FIELD OF THE INVENTION

The invention relates to a method for controlling and in particular activating an anti droplet system of a pipettor and a pipettor with an implemented control for an anti droplet system. The invention further relates to a computer program product and a computer-readable storage.

### BACKGROUND

Transfer of fluids by means of a pipettor is a crucial and critical step in laboratory system and devices. Not only it should be guaranteed that the exact amount of fluid is pipetted and dispensed, but also that no fluid is lost during processing, since this can lead to cross contamination of samples and therefore to false results.

One of the most known issues in pipettors is dripping. Dripping is caused by the increase of pressure inside the tip of the pipettor due to evaporation of the aspirated fluid. This problem is most severe for volatile fluids with a high vapor pressure. The increase of the pressure inside the tip of the pipettor causes the fluid do be displaced towards the opening of the tip, creating a droplet that can, under circumstances, drop and causes not only inaccuracies due to the loss of volume of the aspirated fluid, but may lead to cross contamination.

However, depending on the laboratory system or device operated, only a small amount of fluids is subject to dripping. The most frequent fluids used being serum and plasma. Under normal laboratory conditions these fluids can be safely pipetted, as long as the time the fluid is held in the pipettor does not exceeds a given time.

Under certain laboratory conditions (which are typically allowed according to specifications), safe pipetting of serum and plasma is not ensured. The problem is especially severe when a multipipettor is used, and the time between aspiration and dispensing of the multiple fluids is prolonged, e.g. because the aspiration of the multiple fluids cannot be done in parallel, but only sequentially, or a clot is detected when aspirating a fluid. In this case, a clot handling workflow is executed, which typically takes longer than the normal fluid transfer does because the pipetting tip with the clotted sample has to be disposed or an error handling process has to be performed.

In addition, modern laboratory system and devices that are fully automated have a closed working area due to security reasons (multiple robotic handlers moving, avoid contamination, user safety), and, depending on the type of the system or device, the conditions inside the working area may drastically differ from the outside laboratory condition. As an example, in fully automated nucleic acid analyzers, after several hours of operation, due to the presence of heat generating components such as thermal incubators and thermocyclers, the temperature is generally higher and the relative humidity lower than in the laboratory.

A known method to avoid dripping is to monitor the pressure inside the tip of the pipettor by means of a pressure sensor. After aspiration of the fluid, the pressure is continuously monitored and adjusted in case the pressure raises by moving the plunger of the pipettor, therefore avoiding drop formation and dripping. While this process can actively avoid dripping of the fluid, its activation may not be realiable and therefore activation can lead to pipetting inaccuracies. In some cases, the environmental conditions in the working area can lead to a pressure drop instead of a pressure increase in the pipettor tip, therefore increasing pipetting errors. Alternative methods are disclosed exemplarily in EP 0596213 A1, US 2007/0102445 A1, US 2007/0241130 A1 or U.S. Pat. No. 5,537,880.

It is therefore aim of the present invention to provide a method and a laboratory system or device with an high pipetting accuracy, while at the same time avoiding dripping of fluid during pipetting.

This problem is solved with a method and a laboratory system or device according to the independent claims.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

According to the present invention, the laboratory system or device comprises at least one air displacement pipettor arranged in a working area of the laboratory system or device, wherein the displacement pipettor comprises a pressure sensor for monitoring the pressure above a fluid column in a pipettor tip.

The pipettor according to the present invention is therefore capable of being operated with an anti droplet system as cited above and which will be disclosed again later.

The system or device further comprises at least one humidity sensor for monitoring the humidity in the working area and at least one temperature sensor for monitoring the air temperature in the working area. The sensors are preferably arranged, in particular in the case of a large working area, in proximity of the pipettor, more preferably directly on the pipettor head which is generally displaceable within the working area.

The system or device further comprises a control unit for controlling operation of the pipettor. The control unit may be a dedicated control unit of the pipettor and be controlled by an higher ranked control system or may be integrated in a control system, e.g. a computer, of the laboratory system or device.

The control unit is connected with the pipettor and is configured to operate the pipettor, in particular to displace air within a pipettor tip to aspirate/deliver fluid. Air displacement is preferably performed by means of a movable plunger as known in the art. The pressure sensor si also connected to the control unit as will be explained later on.

According to the invention, the control unit is connected to the humidity sensor. A humidity value is generated by the humidity sensor and transmitted to the control unit.

Accordingly the control unit is also connected to the temperature sensor. A temperature value is generated by the temperature sensor and transmitted to the control unit.

Therefore, the control unit can determine the humidity and temperature values of the environment of the working area during operation of the pipette.

A threshold database is connected to the control unit. The threshold database has stored a plurality of pairs of humidity and temperature values, wherein instructions to activate or deactivate an anti droplet control system are associated with each pair of humidity and temperature values. The threshold database may be implemented e.g. as a lookup table, and preferably comprises pairs of humidity and temperature values associated with the instructions for values for which operation of the system or device is allowed.

A possible implementation of the threshold database is just to define a threshold humidity and temperature value. Therefore, if the temperature value is above the threshold temperature value and the humidity value is below the threshold value, it is determined that the anti droplet control system has to be activated. However, the threshold database preferably comprises different threshold values depending on the measured humidity and temperature.

The control unit compares the pair of humidity and temperature values obtained from the humidity and temperature sensors with the threshold database and determines which instructions are associated with the obtained humidity and temperature values in order to activate or deactivate the anti droplet control system.

With such a method or system or device, it is possible to only activate the anti droplet control system when necessary, without the risk that the anti droplet control system could influence the pipetting accuracy as explained above because the environment in the working area is not considered critical for drop formation.

As explained above, every anti droplet control system known in the art may be used with the present invention, however, the preferred anti droplet control system comprises monitoring the pressure above a fluid column in the pipettor tip during operation of the pipettor. The control unit, which is connected to the pressure sensor, is therefore capable of monitoring in real time the pressure in the pipettor. If a pressure increase over a predetermined threshold above the fluid column in the pipettor tip is determined by the control unit, then the pipettor is controlled to decrease the pressure above the fluid column below the predetermined threshold by displacing air above the fluid column, e.g. by displacing the plunger of the pipettor.

Therefore, drop formation at the pipettor tip may be avoided.

Preferably, the threshold database also comprises other parameters associated with the different pairs of humidity and temperature values stored therein. Preferably, the parameters comprise a fluid type, an assay type, a rack type, a tube type and/or a clot handling workflow status.

As an example, different fluid types may be processed in the system or device. Therefore, the different fluid types may be associated with different thresholds in the threshold database. The control unit has knowledge or may request to an associated system which fluid is being pipetted and can determine if the anti droplet control system for the determined pair of humidity and temperature values and for the specific fluid being pipetted hast to be activated or deactivated. Accordingly, a rack type used in the system or device for holding containers may be used in connection with the determined humidity and temperature values to determine if the anti droplet control system for the determined pair of humidity and temperature values and for the specific rack being processed hast to be activated or deactivated. A possible implementation to simplify operation of a system or device is that fluids that are prone to dripping are arranged in a dedicated rack, such that the system or device may be easily process the fluids without the need of checking for each individual container on the rack the fluid type contained therein. Accordingly, the tube type and/or the clot handling workflow status, meaning the operational status (active/inactive) of the handling of the fluid when a clot is detected within the pipettor, may also be used alternatively or in connection with the other factors to determine the status of the anti droplet control system.

Although described with regard to the method according to the present invention, the description above applies accordingly to the system or device, the computer program product and the computer readable medium according to the present invention.

### SHORT DESCRIPTION OF THE FIGURES

FIG. 1 depicts a possible implementation of the threshold database according to an embodiment of the present invention; and

FIG. 2 depicts another possible implementation of the threshold database according to an embodiment of the present invention.

### DETAILED DESCRIPTION OF THE FIGURES

The invention will be described now by way of preferred embodiments in connection with the drawings.

According to the present invention, the laboratory system or device comprises at least one air displacement pipettor arranged in a working area of the laboratory system or device, wherein the displacement pipettor comprises a pressure sensor for monitoring the pressure above a fluid column in a pipettor tip.

The pipettor according to the present invention is therefore capable of being operated with an anti droplet system as cited above and which will be disclosed again later.

The system or device further comprises at least one humidity sensor for monitoring the humidity in the working area and at least one temperature sensor for monitoring the air temperature in the working area. The sensors are preferably arranged, in particular in the case of a large working area, in proximity of the pipettor, more preferably directly on the pipettor head which is generally displaceable within the working area.

The system or device further comprises a control unit for controlling operation of the pipettor. The control unit may be a dedicated control unit of the pipettor and be controlled by an higher ranked control system or may be integrated in a control system, e.g. a computer, of the laboratory system or device.

The control unit is connected with the pipettor and is configured to operate the pipettor, in particular to displace air within a pipettor tip to aspirate/deliver fluid. Air displacement is preferably performed by means of a movable plunger as known in the art. The pressure sensor si also connected to the control unit as will be explained later on.

According to the invention, the control unit is connected to the humidity sensor. A humidity value is generated by the humidity sensor and transmitted to the control unit.

Accordingly the control unit is also connected to the temperature sensor. A temperature value is generated by the temperature sensor and transmitted to the control unit.

Therefore, the control unit can determine the humidity and temperature values of the environment of the working area during operation of the pipette.

A threshold database is connected to the control unit. The threshold database has stored a plurality of pairs of humidity and temperature values, wherein instructions to activate or deactivate an anti droplet control system are associated with each pair of humidity and temperature values. The threshold database may be implemented e.g. as a lookup table, and preferably comprises pairs of humidity and temperature values associated with the instructions for values for which operation of the system or device is allowed.

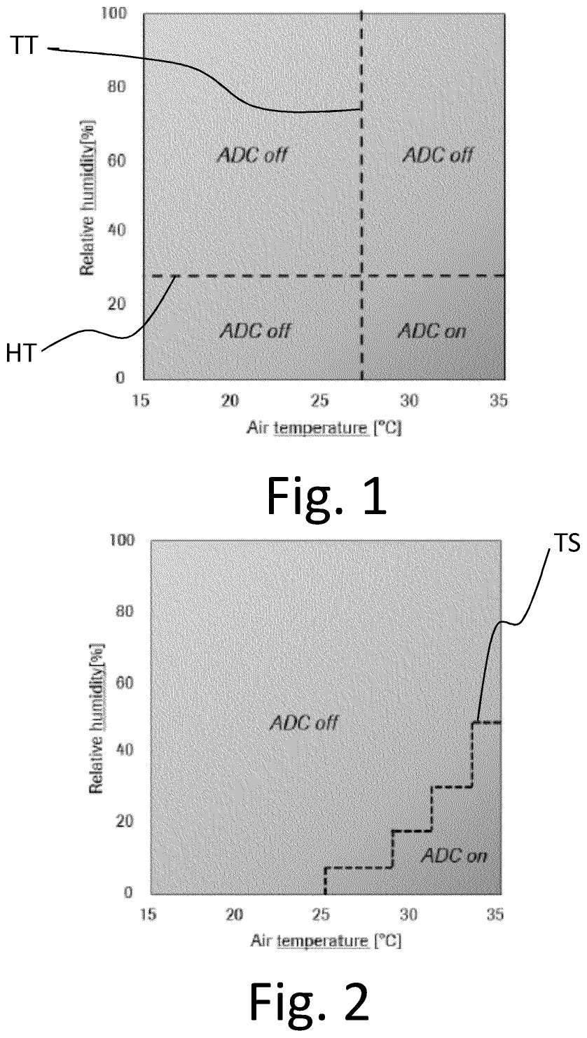

A possible implementation of the threshold database is shown in FIG. 1

A threshold humidity value HT and threshold temperature value TT have been defined. Therefore, if the temperature value is above the threshold temperature value TT and the humidity value is below the humidity threshold value HT, it is determined that the anti droplet control system has to be activated (ADC on). In the other cases, the anti droplet control system is not activated during operation of the pipettor (ADC off)

The threshold database preferably comprises different threshold values depending on the measured humidity and temperature, as shown in FIG. 2. There, contraty to the example of FIG. 1, only a threshold line, in this case a step line TS, has been defined. Therefore, every pair of humidity and temperature values of the threshold database are associated with an instruction if the anti droplet control system has to be activated (ADC on) or not (ADC off).

The control unit compares the pair of humidity and temperature values obtained from the humidity and temperature sensors with the threshold database and determines which instructions are associated with the obtained humidity and temperature values in order to activate or deactivate the anti droplet control system.

With such a method or system or device, it is possible to only activate the anti droplet control system when necessary, without the risk that the anti droplet control system could influence the pipetting accuracy as explained above because the environment in the working area is not considered critical for drop formation.

As explained above, every anti droplet control system known in the art may be used with the present invention, however, the preferred anti droplet control system comprises monitoring the pressure above a fluid column in the pipettor tip during operation of the pipettor. The control unit, which is connected to the pressure sensor, is therefore capable of monitoring in real time the pressure in the pipettor. If a pressure increase over a predetermined threshold above the fluid column in the pipettor tip is determined by the control unit, then the pipettor is controlled to decrease the pressure above the fluid column below the predetermined threshold by displacing air above the fluid column, e.g. by displacing the plunger of the pipettor.

Therefore, drop formation at the pipettor tip may be avoided.

Preferably, the threshold database also comprises other parameters associated with the different pairs of humidity and temperature values stored therein. Preferably, the parameters comprise a fluid type, an assay type, a rack type, a tube type and/or a clot handling workflow status.

As an example, different fluid types may be processed in the system or device. Therefore, the different fluid types may be associated with different thresholds in the threshold database. The control unit has knowledge or may request to an associated system which fluid is being pipetted and can determine if the anti droplet control system for the determined pair of humidity and temperature values and for the specific fluid being pipetted hast to be activated or deactivated. Accordingly, a rack type used in the system or device for holding containers may be used in connection with the determined humidity and temperature values to determine if the anti droplet control system for the determined pair of humidity and temperature values and for the specific rack being processed hast to be activated or deactivated. A possible implementation to simplify operation of a system or device is that fluids that are prone to dripping are arranged in a dedicated rack, such that the system or device may be easily process the fluids without the need of checking for each individual container on the rack the fluid type contained therein. Accordingly, the tube type and/or the clot handling workflow status, meaning the operational status (active/inactive) of the handling of the fluid when a clot is detected within the pipettor, may also be used alternatively or in connection with the other factors to determine the status of the anti droplet control system.

1. A method for controlling an anti droplet system of a laboratory system, the laboratory system comprising:
at least one air displacement pipettor arranged in a working area of the laboratory system, wherein the displacement pipettor comprises a pressure sensor for monitoring the pressure above a fluid column in a pipettor tip,
at least one humidity sensor for monitoring the humidity in the working area,
at least one temperature sensor for monitoring the air temperature in the working area,
a control unit for controlling operation of the pipettor,
the method comprising the following steps:
the control unit receiving a humidity value from the humidity sensor and a temperature value from the temperature sensor,
the control unit comparing the pair of humidity and temperature values with a threshold database connected to the control unit, the threshold database comprising, for different pairs of humidity and temperature values, instructions to activate or deactivate an anti droplet control system of the pipettor,
the control unit determining if the anti droplet system of the pipettor has to be activated or deactivated,
the control unit activating or deactivating said anti droplet system of the pipettor.

2. The method of claim 1, further comprising the anti droplet system of the pipettor carrying out the following steps:
monitoring the pressure above a fluid column in the pipettor tip,
determining a pressure increase above the fluid column in the pipettor tip over a predetermined threshold, and
decreasing the pressure above the fluid column below the predetermined threshold by displacing air above the fluid column.

3. The method of claim 1, wherein in the threshold database the different pairs of humidity and temperature values are related to other parameters selected from the list comprising fluid type, assay type, rack type, tube type, and clot handling workflow status.

4. A laboratory system, comprising:
at least one air displacement pipettor arranged in a working area of the laboratory system or device, wherein the displacement pipettor comprises a pressure sensor for monitoring the pressure above a fluid column in a pipettor tip,
at least one humidity sensor for monitoring the humidity in the working area,
at least one temperature sensor for monitoring the air temperature in the working area, and
a control unit for controlling operation of the pipettor,
wherein the control unit is configured to:
receive a humidity value from the humidity sensor and a temperature value from the temperature sensor,
compare the pair of humidity and temperature values with a threshold database connected to the control unit, the threshold database comprising, for different pairs of humidity and temperature values, instructions to activate or deactivate an anti droplet control system of the pipettor,
determine if the anti droplet system of the pipettor has to be activated or deactivated,
activate or deactivate said anti droplet system of the pipettor based on the previously performed determination.

5. The system of claim 4, wherein the control unit, upon activation of the anti droplet system, is further configured to:
monitor the pressure above a fluid column in the pipettor tip,
determine a pressure increase above the fluid column in the pipettor tip over a predetermined threshold, and
decrease the pressure above the fluid column below the predetermined threshold by displacing air above the fluid column.

6. The system of claim 5, wherein in the threshold database the different pairs of humidity and temperature values are related to other parameters selected from the list comprising fluid type, assay type, rack type, tube type, and clot handling workflow status.

7. A computer program product comprising instructions to cause a laboratory system comprising at least one air displacement pipettor arranged in a working area of the laboratory system or device, wherein the displacement pipettor comprises a pressure sensor for monitoring the pressure above a fluid column in a pipettor tip, at least one humidity sensor for monitoring the humidity in the working area, at least one temperature sensor for monitoring the air temperature in the working area, and a control unit for controlling operation of the pipettor, to perform the steps of:
the control unit receiving a humidity value from the humidity sensor and a temperature value from the temperature sensor,
the control unit comparing the pair of humidity and temperature values with a threshold database connected to the control unit, the threshold database comprising, for different pairs of humidity and temperature values, instructions to activate or deactivate an anti droplet control system of the pipettor,
the control unit determining if the anti droplet system of the pipettor has to be activated or deactivated, and
the control unit activating or deactivating said anti droplet system of the pipettor.

8. A non-transitory computer-readable storage medium having stored thereon the computer program product of claim 7.
